(19) United States
(12) Patent Application Publication
(10) Pub. No.: US 2006/0254174 A1
(43) Pub. Date: Nov. 16, 2006

(54) Door panel having reinforcing structure

(76) Inventor: Chang Than Chen, Kaohsiung (TW)

Correspondence Address: CHARLES E. BAXLEY, ESQ., 90 JOHN STREET, THIRD FLOOR, NEW YORK, NY, 10038, US

(21) Appl. No.: 11/005,898

(22) Filed: Dec. 7, 2004

(51) Int. Cl. E06B 3/70

(52) U.S. Cl. 52/455

(57) ABSTRACT

A door panel includes an upper beam, a lower beam, and two side beams secured together to form a rectangular configuration. The beams each includes an outer peripheral wall having a partition to separate the beam into an outer portion and a inner portion, the outer portion includes an insert engaged in a chamber, to reinforce the outer portion of the beam, and to allow the outer portion of the beam to be solidly coupled to objects. The inner portion of the beam includes a chamber having one or more reinforcing panels to reinforce the hollow inner portion of the beam. One or more rails may be attached between the side beams, and may be secured between the side beams with catches.

### BACKGROUND OF THE INVENTION

1. Field of the Invention

The present invention relates to a door panel, and more particularly to a door panel having a reinforcing structure for allowing two or more door panels to be solidly secured and coupled together.

2. Description of the Prior Art

Various kinds of typical door panels have been developed and comprise an upper rail and a lower rail, and two side stiles secured together to form a rectangular configuration, and may further comprise one or more rails and/or stiles disposed in lower portion thereof, for reinforcing the lower portion thereof.

For example, U.S. Pat. No. 6,250,040 to Green discloses one of the typical screen doors which includes an upper rail and a lower rail, and two side stiles secured together to form a rectangular configuration, and the rails and the stiles are made of foamed, closed-cell, solid-core polyvinyl chloride, such that the rails and the stiles include a solid structure having a great weight.

For decreasing the weight of the door panels, the applicant has developed various kinds of door panels having hollow structure. For example, U.S. Pat. No. 6,330,902 to Chen and U.S. Pat. No. 6,786,021 to Chen discloses two further typical door panel assemblies each of which also includes an upper rail and a lower rail, and two side stiles secured together to form a rectangular configuration, and the rails and the stiles include a hollow structure for suitably reducing the weight of the door panels.

However, the hollow rails and stiles of different door panels may not be solidly secured together due to the hollow structure of the rails and the stiles.

The present invention has arisen to mitigate and/or obviate the afore-described disadvantages of the conventional door panels.

### SUMMARY OF THE INVENTION

The primary objective of the present invention is to provide a door panel including a reinforcing structure for allowing two or more door panels to be solidly secured and coupled together.

In accordance with one aspect of the invention, there is provided a door panel comprising an upper beam, a lower beam, and two side beams secured together to form a rectangular configuration. The beams each includes an outer peripheral wall having a partition disposed and secured therein, to separate the beam into a first portion and a second portion, the first portion of the beam includes a chamber formed and provided therein, and includes an insert engaged in the chamber of the first portion of the beam, to reinforce the first portion of the beam, and to allow the first portion of the beam to be solidly coupled to objects. The second portion of the beam includes a chamber formed and provided therein, and includes at least one reinforcing panel disposed and secured therein, to reinforce the hollow second portion of the beam, and to form a hollow structure for the second portion of the beam, and for reducing weight of the beam.

One or more rails may further be provided and secured between the side beams with catches. The rails each includes at least two grooves, the catches each includes a first end engaged into the grooves of the rails, and a second end extended out of the rails, and engaged into the second portion of the beam, and engaged through the reinforcing panel, to solidly secure the rails between the side beams with the catches.

The second ends of the catches include an outer diameter greater than that of the first ends of the catches, to form a peripheral shoulder between the second end and the first end of the catch, and to engage with the rails, and to anchor the catches to the rails. The inserts of the beams may be made of foamable materials and/or made of waste materials.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front plan schematic view of a door panel in accordance with the present invention, in which a portion of the door panel has been cut off to show an inner or interior structure of the door panel;

FIG. 2 is a cross sectional view of the door panel, taken along lines 2-2 of FIG. 1; and

FIG. 3 is an enlarged partial cross sectional view of the door panel, illustrating an inner or interior structure of the door panel.

### DETAILED DESCRIPTION OF THE PREFERRED EMBODIMENT

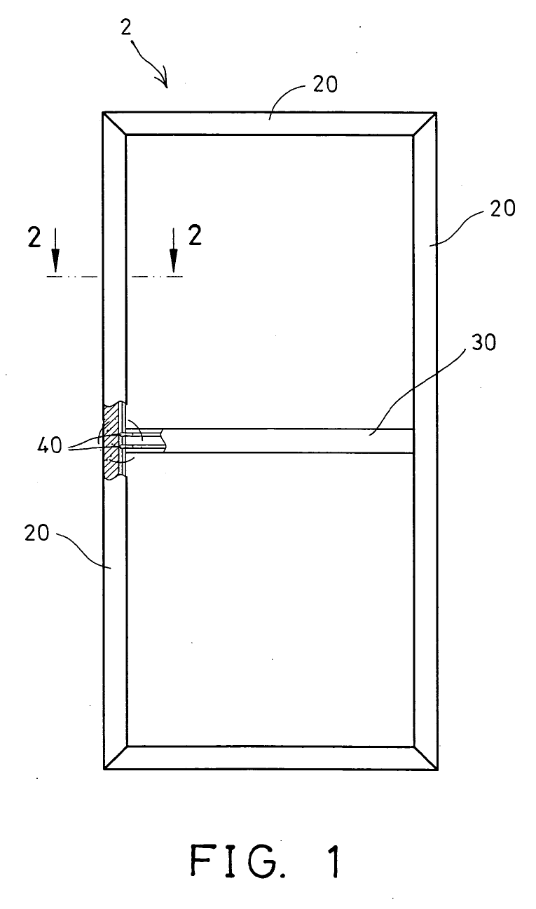

Referring to the drawings, and initially to FIG. 1, a door panel 2 in accordance with the present invention also comprises an upper beam 20 and a lower beam 20, and two side beams 20 secured together to form a rectangular configuration, and one or more additional rails 30 to be secured between the side beams 20 with latch pins or catches 40.

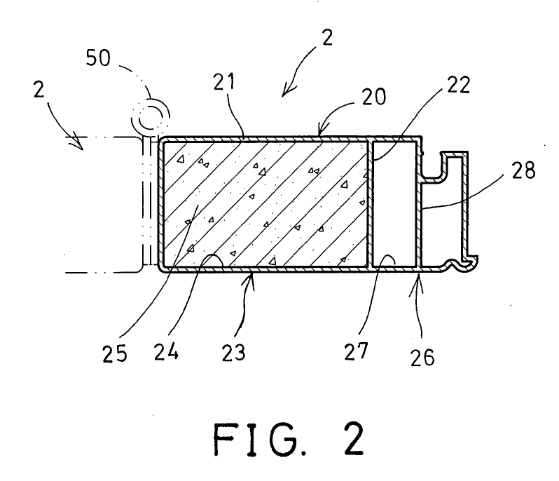

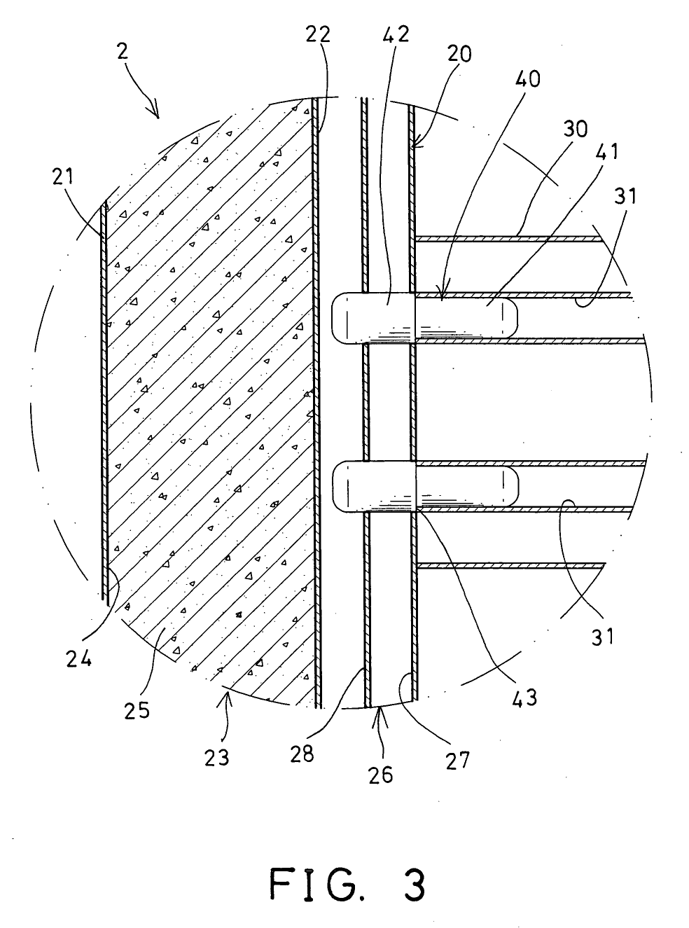

As shown in FIGS. 2 and 3, the beams 20 each includes an outer peripheral wall 21 having a partition 22 disposed and secured therein, to separate the beam 20 into an outer or first portion 23 and an inner or second portion 26; in which the outer or first portion 23 of the beam 20 includes a chamber 24 formed and provided therein for receiving an insert 25 of foamable and/or waste materials, in order to reinforce the outer or first portion 23 of the beam 20, and to allow the outer or first portion 23 of the beam 20 to be solidly coupled to other objects, such as door frames, or other door panels 2 with such as hinges 50 (FIG. 2).

The inner or second portion 26 of the beam 20 also includes a chamber 27 formed and provided therein, and having one or more reinforcing panels 28 disposed and secured therein, to reinforce the hollow inner or second portion 26 of the beam 20. It is to be noted that the inner or second portion 26 of the beam 20 is not required to be secured or coupled to the other objects or door frames, or the other door panels 2, and may thus be made or formed into a hollow structure having no insert engaged therein, such that the weight of the beam 20 may be suitably reduced.

As shown in FIGS. 1 and 3, the rails 30 may each include two or more grooves 31 formed therein, for receiving two or more catches 40. For example, the catches 40 each includes one end or inner end 41 engaged into the corresponding grooves 31 of the rails 30, and the other end or outer end 42 extended out of the rails 30, and engaged into the inner or second portion 26 of the beam 20, and preferably engaged through one or more of the reinforcing panels 28, to allow the rails 30 to be solidly secured between the side beams 20 with catches 40.

It is preferable that the outer ends 42 of the catches 40 each includes an outer diameter greater than that of the inner ends 41 of the catches 40, to form a peripheral shoulder 43 between the outer end 42 and the inner end 41 of the catch 40, and to engage with the rails 30 or the beams 20, and to solidly anchor the catches 40 to the rails 30 and/or the beams 20.

It is to be noted that the catches 40 are arranged perpendicular to the outer peripheral wall 21 and the reinforcing panels 28 of the side beams 20, such that the catches 40 may be solidly secured and anchored to the outer peripheral wall 21 and the reinforcing panels 28 of the side beams 20, and may thus be used to solidly couple and secure the rails 30 and the beams 20 together.

Accordingly, the door panel in accordance with the present invention includes a reinforcing structure for allowing two or more door panels to be solidly secured and coupled together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door panel comprising:
an upper beam, a lower beam, and two side beams secured together to form a rectangular configuration, and.
said beams each including an outer peripheral wall having a partition disposed and secured therein, to separate said beam into a first portion and a second portion, said first portion of said beam including a chamber formed and provided therein, and including an insert engaged in said chamber of said first portion of said beam, to reinforce said first portion of said beam, and to allow said first portion of said beam to be solidly coupled to objects, and
said second portion of said beam including a chamber formed and provided therein, and including at least one reinforcing panel disposed and secured therein, to reinforce said hollow second portion of said beam, and to form a hollow structure for said second portion of said beam, and for reducing weight of said beam.

2. The door panel as claimed in claim 1 further comprising at least one rail secured between said side beams with catches.

3. The door panel as claimed in claim 2, wherein said rails each includes at least two grooves, said catches each includes a first end engaged into said at least two grooves of said rails, and a second end extended out of said rails, and engaged into said second portion of said beam, and engaged through said at least one reinforcing panel, to solidly secure said rails between said side beams with said catches.

4. The door panel as claimed in claim 3, wherein said second ends of said catches include an outer diameter greater than that of said first ends of said catches, to form a peripheral shoulder between said second end and said first end of said catch, and to engage with said rails, and to anchor said catches to said rails.

5. The door panel as claimed in claim 1, wherein said inserts of said beams are made of foamable materials.

6. The door panel as claimed in claim 1, wherein said inserts of said beams are made of waste materials.
